(19) United States
(12) Patent Application Publication
(10) Pub. No.: US 2018/0072365 A1
(43) Pub. Date: Mar. 15, 2018

(54) Universal Footrest for One-Legged Operation of a Stationary Bicycle

(71) Applicant: Joseph Muana-Yeye Kalenga, Kinshasa (CD)

(72) Inventor: Joseph Muana-Yeye Kalenga, Kinshasa (CD)

(21) Appl. No.: 15/813,666

(22) Filed: Nov. 15, 2017

Related U.S. Application Data
(63) Continuation-in-part of application No. 15/172,134, filed on Jun. 2, 2016.
(60) Provisional application No. 62/216,567, filed on Sep. 10, 2015.

(51) Int. Cl. B62J 25/00; B62K 3/16; B62M 1/24

(52) U.S. Cl. CPC B62J 25/00; B62M 1/24; B62K 3/16

(57) ABSTRACT

Various embodiments for an apparatus and method for use of a footrest device with a stationary bicycle are provided. A footrest device includes a forward foundation, a rear foundation, one or more posts that extends in a horizontal direction, wherein at least one end of the one or more posts is coupled to either the forward foundation or the rear foundation. The footrest device includes a platform configured to function as a footrest, and one or more support shafts that extend in a vertical direction upwardly from the one or more posts. A method for using the footrest device includes placing one foot on a platform of the footrest device, placing a second foot on a pedal on the opposite side of the stationary bicycle, and pedaling the pedal of the stationary bicycle with the second foot while the first foot is located on the platform of the footrest device.

### CROSS-REFERENCE TO RELATED APPLICATIONS

This application is a continuation in part application of pending U.S. application Ser. No. 15/172,134, filed on Jun. 2, 2016, which claims the benefit of U.S. provisional patent application 62/216,567, which was filed on Sep. 10, 2015. All of the above-identified applications are fully incorporated herein by reference in their entirety.

### FIELD OF THE DISCLOSURE

This disclosure includes one or more embodiments related to an apparatus that may be used in conjunction with a stationary bicycle for many applications, including, but not limited to, physical therapy, exercise, and muscle strengthening. More specifically, one or more embodiments provided in the disclosure are directed to an apparatus that may be coupled to a structure of a stationary bicycle that includes a footrest on which a user of the stationary bicycle may place one of his or her legs while pedaling the stationary bicycle with the user's other leg.

### BACKGROUND

Rehabilitation is a broad medical field that generally aims to help patients restore body functions and regain quality of life lost due to a medical condition, trauma, or injury. Physical rehabilitation treatments often include massage, electrotherapy, manual exercises, and fitness balls, among other types of treatment. Of particular importance in physical therapy is the stationary exercise bicycle, which serves as an excellent way to introduce varying resistance while providing cardiovascular training. The resistance allows for muscles to grow and strengthen through intermittent sessions on the bicycle.

Commonly, in a rehabilitation setting, only one of the patient's legs has been injured. For example, after a person has used crutches or his or her legs are in a split for weeks or sometimes months, the muscles, tendons, and ligaments of the injured leg are usually significantly weaker than the non-injured leg. If left untreated this can result in additional adverse medical consequences such as instability in the joint and many other adverse medical conditions for the leg.

It is also the case that many athletes such as gymnasts or track and field athletes worry about having legs of differing strength. It is beneficial for athletes to develop the strength of both of their legs, because athletes with legs of equal strength are more versatile as they can lead with either leg. For example, cartwheels or high jumps are usually done with the stronger leg leading.

To strengthen the legs or restore the muscle and support tissues of the leg, those in the art use a stationary bike. However, a standard stationary bike requires the use of both legs, including a leg that is weaker than the other one.

Thus, in the field of rehabilitation and exercise there exists a need for a stationary cycle that can be comfortably operated with only one leg. This would allow the previously injured leg to be exercised while the healthy leg remains at rest. Thus, the previously injured leg can be returned to parity with the healthy leg. A naturally weaker leg could also be given extra workouts and special attention.

### SUMMARY

In one aspect, an apparatus, according to illustrative embodiments that are described herein, is provided, whereby the apparatus is a footrest device for use with a stationary bicycle. In one exemplary embodiment, the footrest device includes a forward foundation and a rear foundation, which are both structural members of the footrest device. The footrest device may also include one or more posts that extend in a horizontal direction between the forward foundation and the rear foundation, whereby at least one end of the one or more posts is coupled to either the forward foundation or the rear foundation. Further, the footrest device may include a platform configured to function as a footrest for a user to place his or her foot upon (while using the other foot to pedal the pedal on the opposite side of the stationary bicycle). Further, the footrest device, in one or more non-limiting embodiments, may include one or more support shafts that extend in a vertical direction in an upward direction and orientation from the one or more posts, whereby an underside of the platform is coupled to an upper end of the one or more posts.

In another aspect, an exemplary method for using a footrest device with a stationary bicycle is included in the present disclosure. In one, non-limiting embodiment, a method may include coupling a footrest device to a first side of the stationary bicycle and placing one foot of a rider of the stationary bicycle on the platform coupled to the footrest device. Further, the method may include placing a second foot of the rider on a pedal of the stationary bicycle, the pedal being located on an opposite side of the stationary bicycle with respect to the location of the footrest device. The method may further include pedaling the pedal of the stationary bicycle with the second foot while the first foot is located on the platform of the footrest device.

Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 illustrates a side view of an exemplary footrest device in accordance with embodiments in the present disclosure.

FIG. 2 illustrates a perspective view of an exemplary footrest device in accordance with embodiments in the present disclosure.

FIG. 3 illustrates a front view of a forward foundation member on an exemplary footrest device in accordance with embodiments in the present disclosure.

FIG. 4A illustrates a top view of a footrest device that is in a retracted position in accordance with embodiments in the present disclosure.

FIG. 4B illustrates a top view of a footrest device that is in an expanded position in accordance with embodiments in the present disclosure.

FIG. 5A illustrates a footrest device located on one side of a stationary bicycle in accordance with embodiments in the present disclosure.

FIG. 5B illustrates the footrest device of FIG. 5A on another side of the stationary bicycle in accordance with embodiments in the present disclosure.

FIG. 5C illustrates the footrest device of FIG. 5A and FIG. 5B in accordance with embodiments in the present disclosure.

FIG. 6 illustrates a pictorial view of an exemplary footrest device coupled to a stationary bike with a human user using the exemplary footrest device in accordance with embodiments in the present disclosure.

FIG. 7 illustrates a flowchart for an exemplary process of using a footrest in accordance with embodiments in the present disclosure.

### DETAILED DESCRIPTION

In the Summary above, this Detailed Description, the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40%or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items,” may indicate the presence of only one item, or may indicate more items. Thus, the term “set” may be equivalent to “one or more” and equivalent to “at least one” as used herein.

Embodiments in the present disclosure are related to a system, apparatus, and method for a universal footrest that may be used with a stationary bicycle. There are many foreseeable uses for such embodiments. For example, without limitation, in the field of rehabilitation and exercise there exists a need for a stationary bicycle that can be comfortably operated with only one leg. There are many reasons why a user is not comfortable using or is unable to use both legs to comfortably pedal and bike on a stationary bicycle. For example, a user may have experienced an injury. Such a footrest device would allow the previously injured leg to be exercised while the healthy leg remains at rest. Thus, the previously injured leg can be returned to parity with the healthy leg.

In the field of exercise, r a footrest device may allow a user with a weaker leg as compared to the other to strength the weaker leg by focusing extra attention on the weaker leg via special workouts using a footrest for use with a stationary bicycle as disclosed in one or more embodiments in the present disclosure. Additional details are provided below for a structure and method of use of a footrest device, according to one or more embodiments, with respect to the drawings.

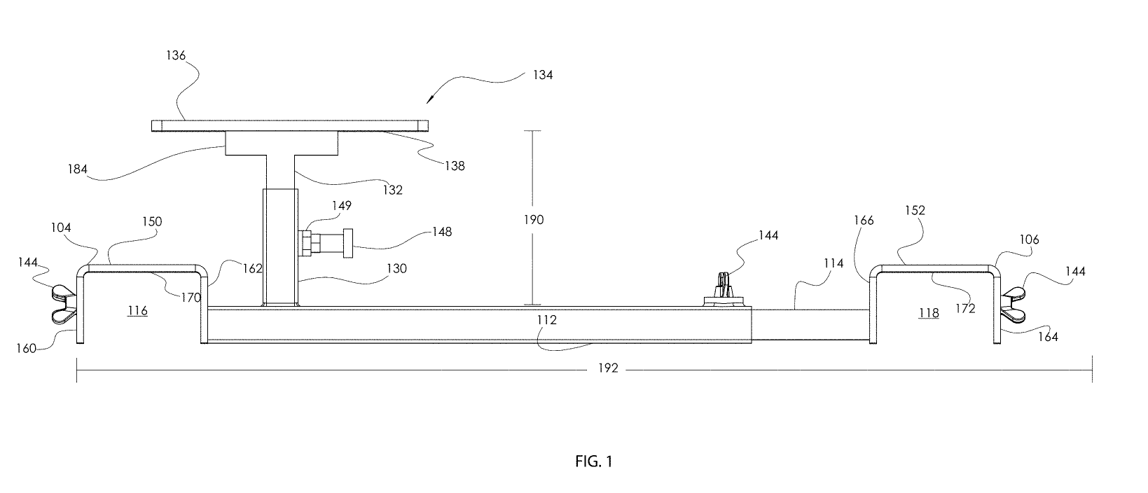

Turning to FIG. 1, FIG. 1 shows a side view of an exemplary footrest device in accordance with embodiments in the present disclosure. Footrest device 102 is an example of a universal footrest that may be coupled to a stationary bicycle, and used for many beneficial uses. Examples of such beneficial uses include, but are not limited, for physical therapy purpose or for exercise to strengthen, tone, and a person's leg's muscles and to improve a person's overall health, including cardiovascular health. Other alternative uses and applications are intended to be included within the scope of the one or more embodiments for footrest device 102 presented in the present disclosure.

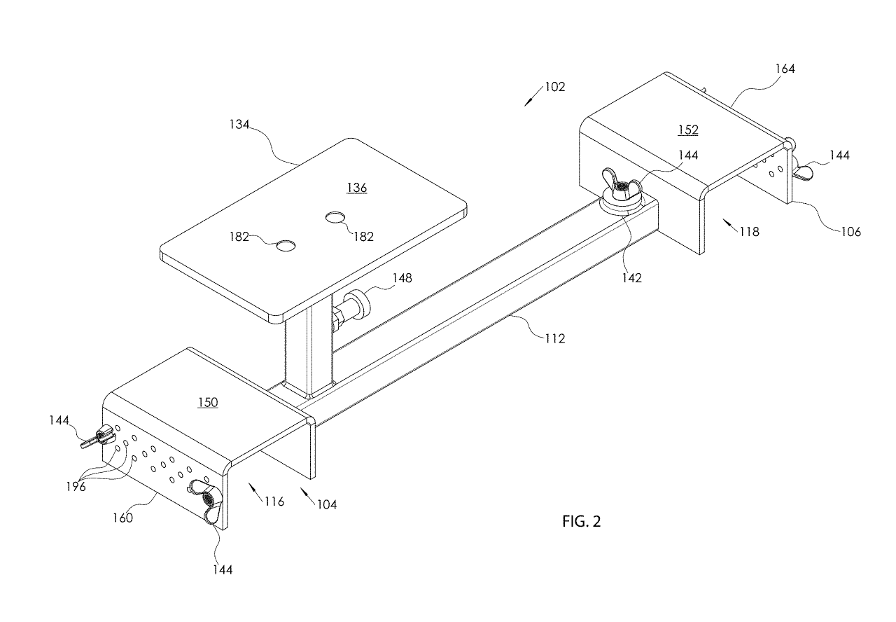

FIG. 2 may also be helpful to view to better understand the exemplary embodiment of a footrest device as shown in FIG. 1. FIG. 2 shows a perspective view of footrest device 102. Footrest device 102, in one or more embodiments, may have a number of structural components included that make up its base. In one or more embodiments, a base or main body of footrest device 102 may include a forward foundation 104, rear foundation 106, as well one or more horizontal support posts (e.g. 112 and 114) that join at a point, such as joint 110 (e.g. as shown in FIG. 2). At joint 110, in some embodiments, a first post, such as post 112 and a second post, such as second post 114 may be connectable according to any suitable manner known in the art.

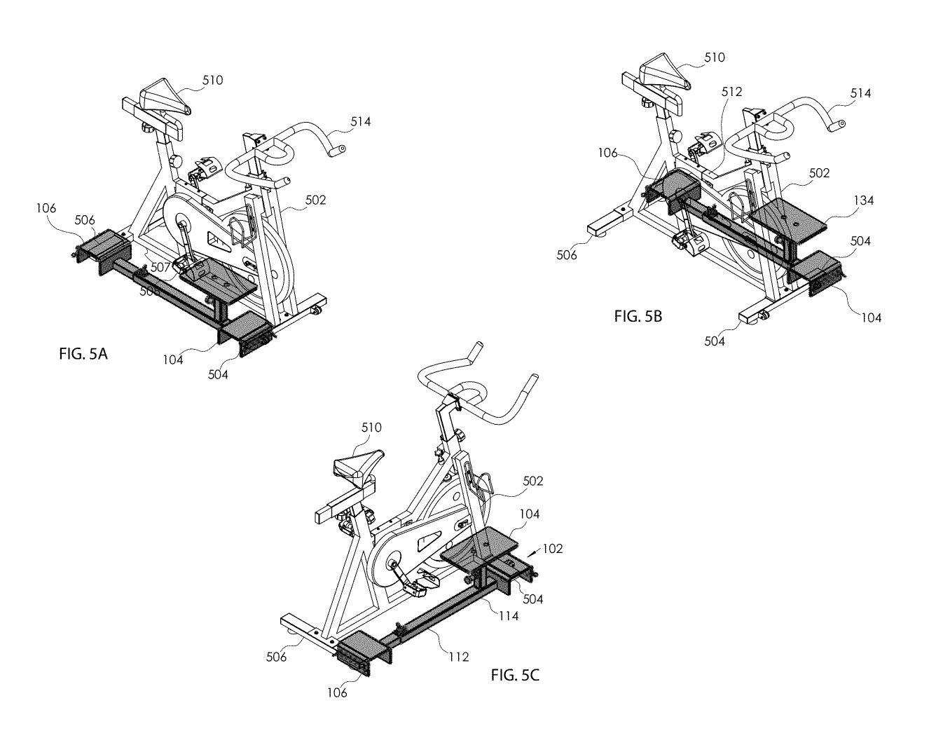

Forward foundation 104 and rear foundation 106 may be structural members of footrest device 102 that are adapted to be connected to and/or at least located over a stabilizer bar of a stationary bicycle (e.g. 502 in FIG. 5). Accordingly, in one or more embodiments, forward foundation 104 may be adapted to be located over a front stabilizer bar of a stationary bicycle (e.g. front stabilizer bar 504 of stationary bicycle 502 as shown in FIG. 5). Further, rear foundation 106 may be adapted to be coupled to, positioned over, or otherwise attached to a rear stabilizer bar of a stationary bicycle (e.g. rear stabilizer bar 506 of stationary bicycle 502 as shown in FIGS. 5A-5C).

In one or more embodiments, forward foundation 104 and rear foundation 106 may have the same general appearance and shape. However, those of ordinary skill in the art will appreciate that, in alternative embodiments, forward foundation 104 may be designed to have a different general appearance and shape than rear foundation 106.

In one or more embodiments, forward foundation 104 and rear foundation 106 may each, respectively, have a front face and a back face. As shown in FIG. 1, forward foundation 104 may have front face 160 and back face 162. Likewise, rear foundation 106 may have a front face, such as front face 164 and a back face, such as back face 166.

In addition to the above, forward foundation 104 may include a top surface, such as top surface 150. Rear foundation 106 may similarly include a top surface, such as top surface 152. Forward foundation 104 of footrest device 102 may further include an underside, such as underside 170, which is on the interior side of forward foundation 104. Rear foundation 106 of footrest device 102 may also include an underside, such as underside 172, which is the surface located on an interior side of rear foundation 106.

Further, forward foundation 104 and rear foundation 106 may each include its own cavity, such as cavity 116 and cavity 118, shown in FIGS. 1 and 2. Cavity 116 and cavity 118 are empty areas formed out of an interior area of the body, respectively, of forward foundation 104 and rear foundation 106. Thus, in some embodiments, the interior surfaces of front face 160, top surface 150, and back face 162 of forward foundation 104 may define or enclose cavity 116. Likewise, in some embodiments, the interior surfaces of front face 164, top surface 152, and back face 166 may define or enclose cavity 118 for the rear foundation 106 of footrest device 102.

In one or more embodiments, cavity 116 and cavity 118 may provide enough room and clearance for forward foundation 104 and rear foundation 106 to fit over a stabilizer bar of a stationary bicycle, such as front stabilizer bar 504 and rear stabilizer bar 506 for stationary bicycle 502, as shown in FIG. 5, and further described later below in the present disclosure.

As shown in FIG. 1, and throughout the drawings included with the present disclosure, forward foundation 104 and rear foundation 106 are generally manufactured having a generally inverted rectangular C-shape, and each include a front face (e.g. 160, 164), a back face (e.g. 162, 166), a top surface (e.g. 150, 152), and cavity (e.g. 116, 118) defined by the interior surfaces of forward foundation 104 and rear foundation 106. Thus, in some embodiments and as shown in FIGS. 1-6, front face 160 is perpendicular to top surface 150 of the forward foundation 104, and the top surface 150 is perpendicular to back face 162 of forward foundation 104. Likewise, in some embodiments, front face 164 is perpendicular to top surface 152 of rear foundation 106, and top surface 152 is perpendicular to back face 164 of rear foundation 106.

During use of footrest device 102, forward foundation 104 and rear foundation 106 may be oriented so that top surfaces 150 and 152 face in an upward direction and the bottom surfaces of footrest device 102 are flush with a ground level surface (i.e. will be in contact with the floor or ground or other flat surface).

It is noted that forward foundation 104 and rear foundation 106 are not limited in appearance and shape to the rectangular, inverted C shape shown in FIG. 1. Forward foundation 104, and rear foundation 106 may have many other suitable shapes and configurations. For example, while not shown herein, forward foundation 104 and rear foundation 106 may have a curved upper surface (e.g. top surfaces 150 and 152) rather than a flat surface (e.g. as shown in FIG. 1). Those of ordinary skill in the art will also appreciate that forward foundation 104 and rear foundation 106 may be made having any suitable measurements and dimensions (and are not limited to the general dimensions shown in FIG. 1).

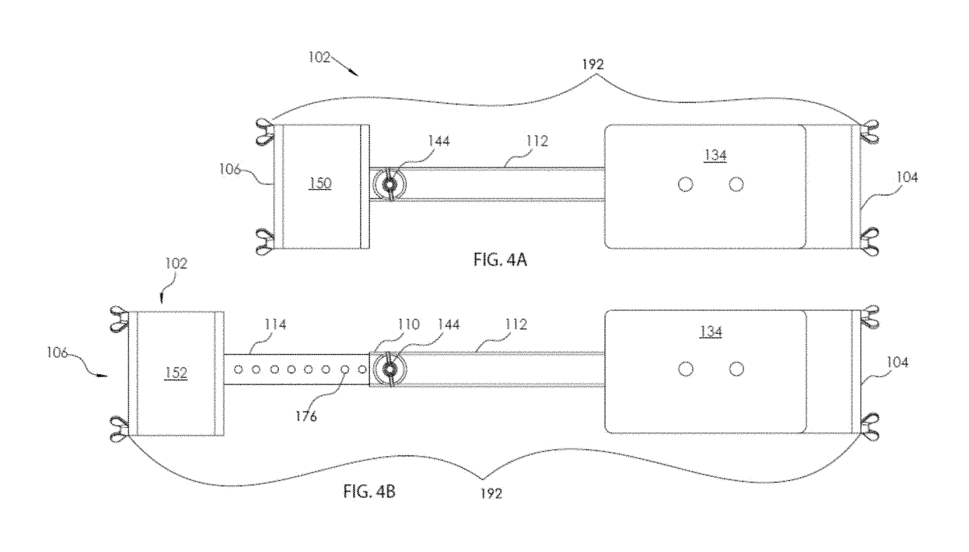

Additionally, in some embodiments, footrest device 102 may include one or more horizontally extending posts, such as first post 112 and second post 114. First post 112 and second post 114 may connect at a joint, such as joint 110 shown in FIG. 4B. It is noted that the one or more horizontally extending posts (e.g. first post 112 and second post 114) may be configured to moveably extend and retract in a horizontal direction.

In the embodiment shown in FIG. 1, first post 112 may include a bore that extends through the body of first post 112. Similarly, second post 114 may also include its own bore that extends through the body of second post 114. In some embodiments, one end of second post 114 may be insertable within the bore extending through the body of first post 112 (e.g. as more clearly shown FIGS. 4A-4B).

Further, in one or more embodiments, first post 112 and/or second post 114 may each include one or more fastener holes (e.g. fastener holes 176 shown in FIG. 4B) disposed thereon. In some embodiments, the one or more fastener holes 176 (shown in FIG. 4B) may extend at least through a top surface of the first post 112 and the second post 114. Alternatively, the one or more holes 176 may extend all the way through the top surfaces and the bottom surfaces of the first post 112 and the second post 114.

In some embodiments, a fastener, such as fastener 144, may be removably inserted into the one or more holes 176 of first post 112 and/or the one or more holes of second post 114. Accordingly, first post 112 and second post 114 may be held in place with the use of a fastener, such as fastener 144.

As used throughout the present disclosure, a fastener may be any type of suitable fastener known in the art, which includes, but is not limited to, pins, screws, nuts and bolts (including wing nuts and bolts), or any other suitable fastener. Alternatively, instead of using a fastener, a c-clamp or any other type of clamp may be used to connect any two parts to the other. Thus, c-clamps or other clamps may be useful to couple parts of footrest device together or to members of a stationary bicycle in alternative embodiments.

As shown in FIG. 1 and FIG. 2 (and throughout the drawings of the present disclosure), wing nut fasteners are the fasteners 144 that are inserted into one or more fastener holes (e.g. 176, 180, and 196) to attach one item to another respective item, although other types of fasteners may be used as well instead of wing nut fasteners. It is noted that it may be preferable for fastener 144 to be removable. However, there may be embodiments whereby fastener 144 is permanently coupled to one or more components of footrest device 102. In still other embodiments, any other means of attachment may alternatively be used, including, but not limited to the use of Velcro, adhesives, welding, riveting, or any other suitable method for attaching two parts to one another.

Continuing with footrest device 102 of FIG. 1 and FIG. 2, in one or more embodiments, an outer diameter of first post 112 may be larger than an outer diameter of second post 114. This may enable one end of the second post 114 to be inserted into a bore of first post 112 and the user may select where to insert a fastener to connect first post 112 and second post 114 at joint 110 shown in FIG. 4B. The second post 114 may be inserted into the bore of the first post 112 as far into the bore as necessary to fit between a front stabilizer bar of a stationary bicycle and a rear stabilizer bar of the stationary bicycle.

In one or more embodiments, the second post 114 may be configured to be extendable within an inner bore (not shown) of first post 112 so as to adjust an overall length 192 of footrest device 102. This may be desirable in order for footrest device 102 to be useable with multiple types and sizes of stationary bicycles, including stationary bicycle.

It is noted that instead of the two connecting posts (such as first post 112 and second post 114) there may be a single horizontally extending post. Further, such a single horizontally extending post may be configured to fit substantially the exact distance between the front stabilizer bar and the rear stabilizer bar. With such an embodiment, each stationary bicycle may come with it is own footrest device having already pre-determined, non-changeable dimensions between a forward foundation 104 and a rear foundation 106.

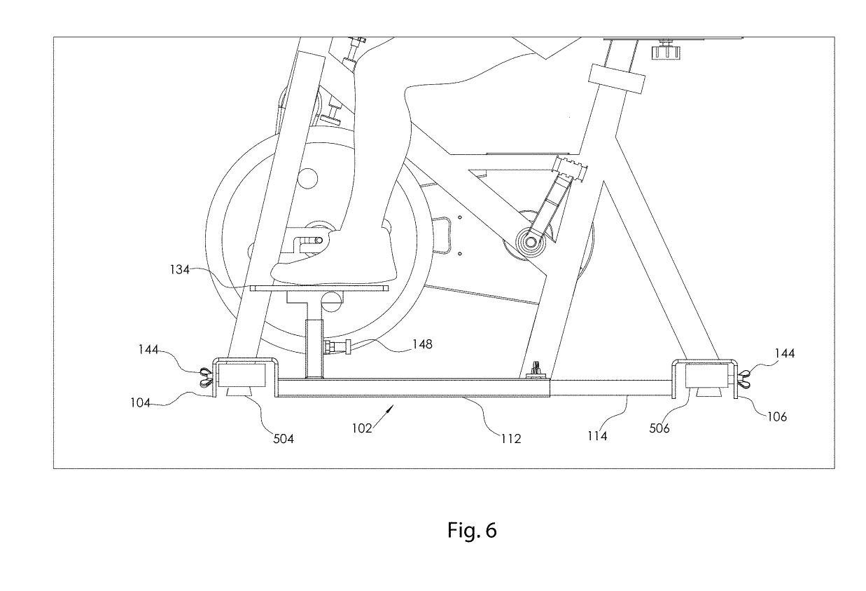

As shown in FIGS. 1 and 2, footrest device 102 further includes platform 134. Platform 134 may be a suitable platform that may function as a footrest for a stationary bicycle rider to rest his or her foot against (e.g. as shown in FIG. 6). Platform 134 may have a top surface 136 and bottom surface 138. In some embodiments, platform 134 may be generally rectangular shaped and flat. In one or more embodiments, it may be helpful for platform 134 to be flat so that a rider's foot may conveniently rest against the top surface 136 of platform 134. However, it is noted, that platform 134 may be manufactured to have any suitable shape or configuration, including having one or more curves, tapered surfaces, and to be configured in non-rectangular shapes. In other embodiments, platform 134 may include non-slip and additional gripping stickers or labels (not shown) on its top surface to prevent a rider's foot from slipping when resting against top surface 136 of platform 134.

In one or more embodiments, footrest device 102 may include one or more vertical support shafts such as first support shaft 130 and second support shaft 132. First support shaft 130 may be a vertical support that extends upwardly from a top surface of first post 112. First support shaft 130 may be integrally formed with first post 112 in one or more embodiments or may be otherwise attached or coupled thereto. As shown in FIGS. 1 and 2, first support shaft 130 is perpendicularly to a top surface of first post 112. First support shaft 130 may also include one or more holes (e.g. 142 shown in FIG. 2) extending through a body or at least one surface of first support shaft 130. One or more fasteners, such as fastener 144, may extend through such one or more holes in first support shaft 130.

Second support shaft 132 may be a vertical support that extends downwardly from the bottom surface 138 of platform 134. In one or more non-limiting embodiments, second support shaft 132 may be insertable into a bore located within an interior of first support shaft 130. Accordingly, a diameter of a bore for first support shaft 130 may be larger in size than a diameter for a second support shaft 132. Platform 134 may be coupled to second support shaft 132. Platform 134 may be coupled to second support shaft 132 via block 184, according to one or more non-limiting embodiments. For example, one or more bolts, such as bolts 182 (as shown in FIG. 2) may be used to couple platform 134 to block 184. Those of ordinary skill in the art will appreciate that other any methods of attachment may be used to attach platform 134 to block 184 and second support shaft 132. For example, in other embodiments, platform 134 may be integrally formed with second support shaft 132.

As shown in FIG. 1, in one or more embodiments, a knob, such as knob 148 may be insertable through the one or more fastener holes located in first support shaft 130 and second support shaft 132. Knob 148 may be used, in one or more non-limiting embodiments, to vary a position of second support shaft 132 with respect to first support shaft 130. Knob 148 may be inserted into a knob base, such as knob base 149, that includes one or more washers and/or nuts, in one non-limiting embodiment. Accordingly, having a removeable and adjustable fastener that includes a knob, such as knob 148, may allow for a length of second support shaft 132 to be adjustable so that the overall height, such as overall height 190 of platform 134 is also adjustable to accommodate a height to suit a user located on a stationary bicycle (e.g. the rider shown in FIG. 6). Knob 148 may be rotatable to move a second support shaft 132 to a desired position and it may also be possible for knob 148 and its underlying pin to be pulled out and reinserted into one or more corresponding holes.

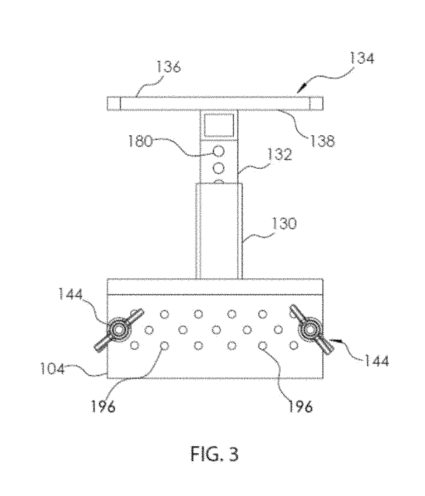

FIG. 3 shows that one or more holes, such as one or more fastener holes 180, may be included in second support shaft 132 and may be used to adjust a height 190 of platform 134. Alternatively, any other method for adjusting a height of platform 134 may be used. For example, second support shaft 132 may telescopically extend from first support shaft 130.

In one or more embodiments, it is possible for platform 134 and second support shaft 132 to be removeably detached from first support shaft 130 and separated from footrest device 102. Such a feature may be useful for conveniently storing footrest device 102. For example, when knob 148 is not inserted through its respective fastener hole that may be disposed through second support shaft 132 and also another fastener hole disposed through first support shaft 130, then a user may detach platform 134 from the remainder of the body of footrest device 102.

Turning to FIG. 3, FIG. 3 shows a frontal view of a forward foundation member of a footrest device according to embodiments of the present description. Thus, FIG. 3 shows forward foundation 104 of footrest device 102 as shown in FIG. 1 and FIG. 2. However, it is noted that, in one or more embodiments, forward foundation 104 may have the same overall appearance, shape, and function as rear foundation 106. Accordingly, in one or more embodiments, front face 160 of forward foundation 104 (as shown in FIGS. 1-2) may be the same in appearance and overall form as front face 164 of rear foundation member 106. Further, back face 162 may be the same in appearance and overall form as back face 166 of rear foundation member 106.

Notably, both forward foundation 104 and rear foundation 106 may include a set of fastener holes, such as set of fastener holes 196 shown in FIG. 3. Accordingly, in one embodiment, at least two fasteners (e.g. as shown in FIG. 3) may be inserted through any one of the set of fastener holes 196 disposed on a front face of either forward foundation 104 and rear foundation 106. Alternatively, more or less fasteners (of any suitable type known in the art) may be included.

The reader is directed to look ahead to FIG. 5A, 5B, and 5C which displays how fasteners, such as fasteners 144 may be inserted through a set of fastener holes 196, that are arranged on front face 160 of forward foundation 104 and front face 164 of rear foundation 106. As further explained below, in such an exemplary manner, forward foundation 104 and rear foundation 106 may be secured to a stationary bicycle (e.g. stationary bicycle 502).

FIG. 3 further shows a view of first support shaft 130, second support shaft 132, and platform 134, which are also part of footrest device 102, in one or more embodiments. First support shaft 130 and second support shaft 132 of footrest device 102 may be vertical support shafts that are generally useful for supporting platform 134. As more clearly shown in FIG. 3, one or more fastener holes 180 may be drilled through a body of second support shaft 132. Further, one or more fastener holes (not shown) may also be drilled through a body of first support shaft 130. Accordingly, to adjust a height of platform 134 (e.g. height 190) the user may insert second shaft 132 into a bore that extends through an interior of first support shaft 130 and select which one of the fastener holes 132 will achieve the desired height 190. A user may align the one or more fastener holes 180 with a fastener hole (not shown) located through first support shaft 130 and insert a fastener (e.g. fastener 144) through both holes. In such a non-limiting example, it is easy and convenient for a user to raise and lower platform 134 to a height level that is most comfortable for the user to rest his or her foot on.

Turning to FIG. 4A and FIG. 4B, FIG. 4A shows a top view of footrest device 102, according to one or more embodiments, in a retracted or shortened position, while FIG. 4B shows a top view of footrest device 102 in an extended and lengthened position. Thus, FIG. 4A and FIG. 4B include additional views showing how a position of second post 114 with respect to first post 112 may be varied and adjusted by a user in order to accommodate a total distance between a front stabilizer bar and a rear stabilizer bar of a stationary bicycle (e.g. a distance between front stabilizer bar 504 and rear stabilizer bar 506 for stationary bicycle 502 as shown in FIG. 5A).

Thus, in one or more embodiments, one or more fastener holes 176 may be located on second post 114 and may be configured to align with a fastener hole, such as fastener hole 142 shown in FIG. 2 that extends through first post 112. Any suitable number of fastener holes 176 may be located on second support shaft 114 (and/or first support shaft 112), and are not limited to the number or spacing of fastener holes as shown in the drawings.

As noted above, in one or more embodiments, first post 112 may include its own interior bore (not shown) adapted for receiving second post 114. Accordingly, a user is able to insert second post 114 within the bore of first post 114 in order to shorten or lengthen the total length 192 of footrest device 102. A user may insert fastener 144 into any one of the fastener holes 176 that best achieves the desired length for total length 192.

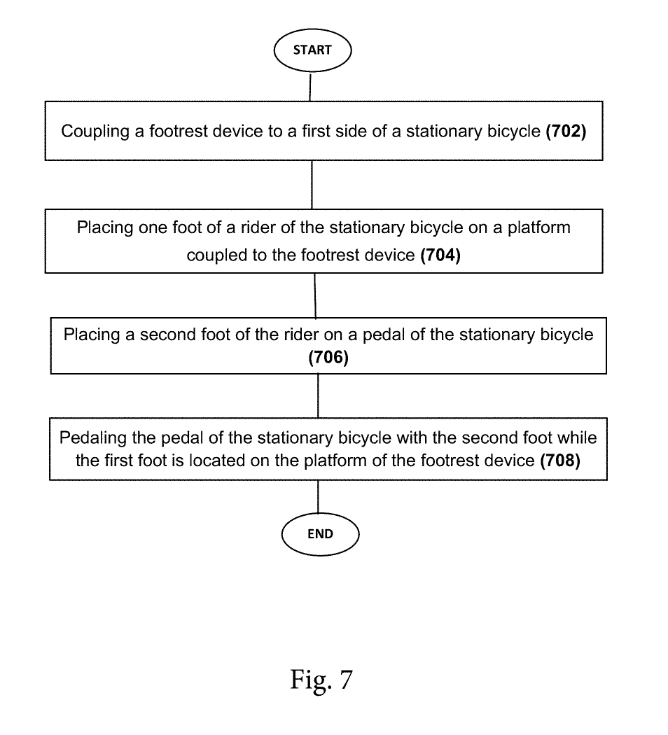

Various convenient elements included with the structure of footrest device 102, according to the non-limiting embodiments described above, may allow footrest device 102 to be described as a “universal” footrest. For example, the ability to adjust a height of platform 134 to various heights to best suit a leg length or build of any user and the ability to extend an overall length 192 of footrest device 102 (by retracting and extending second post 114 with respect to first post 112) may allow footrest device 102 to be used with a variety of stationary bicycles, regardless of their overall measurements and dimensions. However, it is noted that footrest device 102 is not limited to the embodiments shown in FIGS. 1-6 and described in FIG. 7, and other embodiments may not necessarily provide the same functions and features in accordance with everything described above.

Turning to FIGS. 5A-5C, FIGS. 5A-5C show pictorial illustrations of footrest device 102, according to one or more non-limiting embodiments, coupled to a stationary bicycle, such as stationary bicycle 502. Stationary bicycle 502 may represent any type of stationary bicycle known in the art. Stationary bicycles, as known in the art, are a type of exercise or rehabilitation equipment that may be used by placing feet one's on resistive movable pedals attached to a frame of the stationary bicycle.

In accordance with common embodiments of a stationary bicycle, stationary bicycle 502 includes handlebars, such as handlebars 514, a bicycle seat, such as bicycle seat 510, as well as pedals, such as pedals 508, which are located on either side of frame 512 of stationary bicycle 502. A connector bar, such as connector bar 507, connects front stabilizer bar 504 to rear stabilizer bar 506 for stationary bicycle 502.

In one or more embodiments, footrest device 102 may be located on either side of a stationary bicycle. Accordingly, FIG. 5A illustrates that footrest device 102 may be located on a left side of stationary bicycle 502. FIG. 5B and FIG. 5C both show that footrest device 102 may also be moved to the right side of stationary bicycle 502. Thus, footrest device 102 is adapted to be located on either lateral side of a stationary bicycle.

To couple footrest device 102 to a stationary bicycle, such as, but not limited to stationary bicycle 502, a user may begin by placing footrest device 102 such that forward foundation 104 is located over front stabilizer bar 504 of stationary bicycle 502. A user may determine how long the distance is between front stabilizer bar 504 and rear stabilizer bar 506 by measuring it with a tape measure, for example, or simply by visually estimating the distance.

If necessary, a user may adjust an overall length, such as overall length 192, of footrest device 102. To adjust the overall length 192, according to one or more non-limiting embodiments, a user may insert a fastener, such as fastener 144, through the appropriate fastener hole from the set of fastener holes 176 disposed on second post 114 and/or first post 112, after having inserted second post 114 far enough within a bore of first post 114 to secure both posts in place at their connecting joint (e.g. joint 110 shown in FIG. 4B).

After setting the overall needed length 192 of footrest device 102 to correlate to the distance between front stabilizer bar 504 and rear stabilizer bar 506, rear foundation member 106 may be located over rear stabilizer bar 506 of stationary bicycle 502. The cavities (e.g. cavities 116 and 118) located on an underside of forward foundation 104 and rear foundation 106 may allow forward foundation 104 and rear foundation 106 to be located over each stabilizer bar with a reasonable or enough clearance to avoid difficulty positioning the footrest device over each stabilizer bar. It is noted that the above-identified steps may be reversed whereby a user may first locate rear foundation member 106 over rear stabilizer bar 506 and then proceed to adjust an overall length of footrest device 102, rather than begin with forward foundation 104 and front stabilizer bar 504.

Subsequently, a user may desire to secure forward foundation 104 to front stabilizer bar 504, and also to secure rear foundation 106 to rear stabilizer bar 506 of stationary bicycle 502. To do so, a user (i.e. rider) may insert one or more fasteners 144 through one or more fastener holes (e.g. fastener holes 196 as shown in FIG. 3) located on both forward foundation 104 and rear foundation 106. As shown in FIG. 3, there may be many locations for fastener holes 196 such that a user may be able to locate one or more fastener holes 196 that will be aligned with a facing surface of front stabilizer bar 504 and rear stabilizer bar 506. For example, FIG. 3, shows that there are staggered rows of fastener holes 196 with some holes located on an upper level, middle level, and a lower level of rear foundation member 106. Depending on the thickness and height of front stabilizer bar 504 and rear stabilizer bar 506, user may select whichever fastener holes 196 to insert fastener 144 through so as to secure either forward foundation 104 or rear foundation 106 in place. The reader is directed to look to FIG. 6 which shows fasteners 144 extending through the one or more holes 196 to connect with an outer surface of front stabilizer bar 504 and rear stabilizer bar 506 of stationary bicycle 502.

It is noted that, while not shown, it is possible in alternative embodiments that one or more fastener holes may be disposed on a back face of forward foundation 104 and/or rear foundation 106 instead of or in addition to the one or more fastener holes 196 located on front faces 160 and 164 of forward foundation 104 and rear foundation 106. Thus, in alternative embodiments, a user may secure footrest device 102 by inserting fasteners through fastener holes that extend through the back faces (e.g. 162, 166) of forward foundation 104 and rear foundation 106.

Thus, FIG. 5A-5C illustrate that footrest device 102 is designed to be placed on either side of stationary bicycle 502 during operation. Because of the design configuration of footrest device 102, as shown in the exemplary embodiments illustrated herein, when in operation, platform 134 is located near front stabilizer bar 504. Accordingly, a user is able to rest his or her foot on top of platform 134 (e.g. which is further illustrated in FIG. 6).

FIG. 6 illustrates a pictorial view of an exemplary footrest device coupled to a stationary bike with a human user making use of the exemplary footrest device in accordance with embodiments in the present disclosure. As shown in FIG. 6, one or more fasteners 144 is shown extending through front faces 160 and 164, respectively, of forward foundation 104 and rear foundation 106. The fasteners extend through and make contact with an outer surface of both front stabilizer bar 504 and rear stabilizer bar 506 (as shown in FIG. 6). Thus, in one, non-limiting embodiment, the fasteners 144 may be used to detachably couple footrest device 102 to stationary bicycle 502.

As noted above, footrest device 102 may have any number of uses. Nevertheless, it is an object of one or more embodiments of the present disclosure that footrest device 102 may be particularly useful to a number of individuals when used as a physical therapy aid. Thus, a user who has an injured leg or a leg that is in pain for any number of reasons, may be able to rest that particular leg and foot on top of the platform 134 of footrest device 102, while still benefitting from the training and exercise offered by a stationary bicycle, because the user is still able to pedal with the other leg that is located on the pedal on the other side of the frame of the bicycle (e.g. frame 512 of stationary bicycle 502). An equal amount of benefit may be provided to a user who does not necessarily have an injured or distressed leg, but still desires to use footrest device 102 in order to give special attention while biking on a stationary bicycle to one leg over the other. This may be useful, for example, for various athletes who try to prevent one leg from being dominant over the other and would like to develop an equal amount of strength, toning, and speed for each leg.

Further, a height of platform 134 may be adjusted, in one or more embodiments, because platform 134 may be raised or lowered (e.g. by aligning second support shaft 132 at an appropriate fastener hole of the set of fastener holes 180 with a corresponding fastener hole on first support shaft 130).

In alternative embodiments (not shown), forward foundation 104 and rear foundation 106 may be configured to fit over front stabilizer bar 504 and rear stabilizer bar 506 of stationary bicycle 502 using friction fit. Thus, it may be possible for forward foundation 104 to be slid over a top of front stabilizer bar 504 and to fit due to a tight clearance and friction fit. Likewise, it may be possible for rear foundation 106 to be slid over a top surface of rear stabilizer bar 506 and to it due to friction fit as well.

Still yet in one or more alternative embodiments, footrest device 102 may be useful even if forward foundation 104 and rear foundation 106 are not secured to a surface of front stabilizer bar 504 and rear stabilizer bar 506 of stationary bicycle 502. In some cases, a user may choose to only secure one of the foundation members (i.e 104 and 106) of footrest device 102 to a stabilizer bar (i.e. 504 and 506). However, in still other embodiments, a user may simply place the footrest device 102 so that it is flat on a ground or floor level. Subsequently, user may just place his or her desired foot (either right or left foot) on a top of platform 134 of footrest device 102, and start pedaling with the other leg. Footrest device 102 may be adapted to be used thus to accommodate stationary bicycles that do not necessarily have a front stabilizer bar, such as front stabilizer bar 504, and/or a rear stabilizer bar, such as rear stabilizer bar 506.

It is noted that footrest device 102, and any one or more components listed herein, may be made for any type of material known in the art, including without limitation, rubber, carbon fiber, plastic polymer, aluminum, titanium, steel, metal alloy, or other common structural materials common in the art or a combination thereof. Further, footrest device 102 may be visually appealing in one or more combination of colors or may be a single color without preference thereto.

FIG. 7 illustrates a flowchart for an exemplary process of using a footrest device for the, one-legged operation of a stationary bicycle in accordance with embodiments in the present disclosure. The exemplary process shown in FIG. 7 may include the use of a footrest device, such as footrest device 102 shown in FIGS. 1-6 and described above.

At step 702, the process may begin by coupling a footrest device to a first side of a stationary bicycle. A process for coupling a footrest device to one side of stationary bicycle is described above with respect to FIGS. 5A-5C. It is further noted that instead of coupling the footrest device to a first side of a stationary bicycle, a user may alternatively place footrest device proximate to one side of stationary bicycle and on the floor. The bottom surface of footrest device 102 may rest against a floor surface and be supported. Thus, it is not required in alternative embodiments that either or both forward foundation 104 and 106 of footrest device 102 be coupled to (e.g. via fasteners 144 or via friction fit as described above) to stabilizer bars 504 and 506 of stationary bicycle 502. However, it is noted that it may be beneficial to couple and secure footrest device 102 to a structural member of stationary bicycle, such as stationary bicycle 502, may contribute to additional stability of the footrest device 102 and keep the footrest device 102 from any type of side to side movement.

At step 704, a user may place one of his or her feet on a platform of a foot rest device (e.g. as shown in FIG. 6). In operation, the platform, such as platform 134 is located near the front of the stationary bicycle such that a user may place his foot on top of the platform 134 and towards the front of the stationary bicycle. Next, at step 706, the user may place his or her other foot on a pedal of the stationary bicycle located on the opposite side of the footrest device. For example, a user may step first onto the platform and then straddle over a bicycle seat of the stationary bicycle to put his or her foot on the pedal located on the other side of the stationary bicycle where the footrest device has not been placed. Thus, it may be necessary for the user to make a determination in advance which leg he or she is intending to pedal with so as to determine which side of the stationary bicycle footrest device 102 will be located. When comfortably situated, the user may begin pedaling the pedal of the stationary bicycle with the second foot while the first foot is located on the platform of the footrest device (at step 708). As previously noted the user may increase or decrease a height of platform 134 to a height that suits the user and may also adjust the length of one or more connector posts (e.g. first post 112, and second post 114) that act as horizontal supports for footrest device 102, in one or more embodiments.

Thus, one or more embodiments provided in the present description allow for the one-legged operation of a stationary bicycle due to the use of a device, such as the footrest device, provided herein. Typically, stationary bicycles require a user to operate both pedals of the stationary bicycle with both his or her feet. However, a footrest device, according to embodiments provided in the present disclosure, changes this common method of using a stationary bicycle and allows for the one legged operation of the stationary bicycle instead.

Beneficially, the one or more embodiments for a footrest device may be useful for many applications, including but not limited to, physical therapy and/or exercise. One or more embodiments described in the present description are advantageous, because the configurations provided allow for a footrest device to adjust to different sizes and dimensions of stationary bicycles. For example, the present description includes one or more embodiments for a footrest device that may be manipulated by a user of footrest device so that an overall height of a platform of footrest device is adjustable to suit the length of a rider's legs. Also, the overall length of a footrest device, according to one or more embodiments, may also be adjustable to suit different sized stationary bicycles that may have varying distances between a front stabilizer bar and a rear stabilizer bar. Because the footrest device, as provided in one or more embodiments herein, may be adjustable in height and length, it may be described as being “universal” and may, advantageously, be used for more than one single type of stationary bicycle having only a certain set of dimensions.

While preferred and alternate embodiments have been illustrated and described, as noted above, many changes can be made without departing from the spirit and scope of the embodiments provided in the present disclosure. Accordingly, the scope of the embodiments provided in the present disclosure is not limited by the disclosure of these preferred and alternate embodiments. Instead, the scope of the invention title be determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112¶6. In particular, the use of “step of” in the claims herein is not intended to invoke the provisions of U.S.C. § 112¶6.

What is claimed is:

1) An apparatus for use with a stationary bicycle, comprising:
a footrest device, further comprising:
a forward foundation and a rear foundation;
one or more posts that extends in a horizontal direction between the forward foundation and the rear foundation, wherein at least one end of the one or more posts is coupled to either the forward foundation or the rear foundation; and
a platform configured to function as a footrest; and
one or more support shafts that extend in a vertical direction upwardly from the one or more posts, wherein an underside of the platform is coupled to an upper end of the one or more support shafts.

2) The footrest apparatus of claim 1, wherein a first cavity is included on the underside of the forward foundation and a second cavity is included on the underside of the rear foundation.

3) The footrest apparatus of claim 1, wherein the one or more posts are configured to movably extend and retract in a horizontal direction.

4) The footrest apparatus of claim 1, wherein the one or more posts comprise a first horizontal post and a second horizontal post, wherein the first horizontal post is configured to be inserted within a bore of the second horizontal post.

5) The footrest apparatus of claim 2, wherein the forward foundation and the rear foundation each include a front face, a back face, and a top surface, wherein the front face and the back face are coupled to the top surface, and wherein an interior surface of each of the front face, the back face, and the top surface defines the cavity.

6) The footrest apparatus of claim 5, wherein the front faces of the forward foundation and of the rear foundation are, respectively, perpendicular to the top surfaces of the forward foundation and to the rear foundation, and wherein the top surfaces of the forward foundation and the rear foundation, are respectively, perpendicular to the back faces of the forward foundation and the rear foundation.

7) The footrest apparatus of claim 5, wherein the back face of the forward foundation is coupled to one end of the first horizontal post and the back face of the rear foundation is coupled to one end of the second horizontal post.

8) The footrest apparatus of claim 5, wherein the front face of the forward foundation and the front face of the rear foundation each include at least one hole extending therethrough, wherein the at least one hole is configured to receive a fastener.

9) The footrest apparatus of claim 5, wherein the back face of the forward foundation and the back face of the rear foundation each include at least one hole extending therethrough, wherein the at least one hole is configured to receive a fastener.

10) The footrest apparatus of claim 5, wherein the first horizontal post and the second horizontal post include one or more holes that extend through at least a top surface of the first horizontal post and the second horizontal post.

11) The footrest apparatus of claim 10, wherein the first horizontal post is coupled to the second horizontal post using a fastener, wherein the fastener is insertable through at least one hole of the one or more holes extending through the second horizontal post and also through the one or more holes of the first horizontal post.

12) The footrest apparatus of claim 1, wherein the one or more support shafts are configured to moveably extend and retract in a vertical direction.

13) The footrest apparatus of claim 1, wherein the one or more support shafts comprise a first support shaft coupled to a second support shaft, wherein the second support shaft is coupled to an underside of the platform.

14) The footrest apparatus of claim 13, wherein a height of the platform is adjustable by adjusting a position of the second support shaft with respect to the first support shaft.

15) The footrest apparatus of claim 13, wherein the second support shaft includes one or more holes disposed along its length such that the one or more holes are alignable with at least one hole disposed on the first support shaft, and wherein a fastener is configured to be removably inserted through the one or more holes of the first support shaft and through the at least one hole of the second support shaft.

16) A method for using a footrest device with a stationary bicycle, comprising:
coupling a footrest device to a first side of the stationary bicycle;
placing one foot of a rider of the stationary bicycle on a platform coupled to the footrest device;
placing a second foot of the rider on a pedal of the stationary bicycle, the pedal being located on an opposite side of the stationary bicycle than the footrest device; and
pedaling the pedal of the stationary bicycle with the second foot while the first foot is located on the platform of the footrest device.

17) The method of claim 16, comprising adjusting a height of the platform of the footrest device to suit the rider.

18) The method of claim 17, wherein coupling a footrest apparatus to a first side of the stationary bicycle further comprises:
coupling a forward foundation of the footrest device to a front stabilizer bar of the stationary bicycle, wherein the platform of the footrest device is located near the front stabilizer bar of the stationary bicycle; and
coupling a rear foundation of the footrest device to a rear stabilizer bar of the stationary bicycle.

19) The method of claim 18, further comprising, using a first fastener to couple the forward foundation to the front stabilizer bar of the stationary bicycle and using a second fastener to couple the rear foundation to the rear stabilizer bar of the stationary bicycle.

20) The method of claim 18, further comprising, adjusting a length of one or more horizontal posts connected to the forward foundation and the rear foundation of the footrest device in order for an overall length of the footrest device to correspond to a distance between the front stabilizer bar and the rear stabilizer bar of the stationary bicycle.
